(19) United States
(12) Patent Application Publication
(10) Pub. No.: US 2010/0179074 A1
(43) Pub. Date: Jul. 15, 2010

(54) METHODS AND APPARATUS FOR FLUID DELIVERY AND REMOVAL OF MICRON SCALE STRUCTURES

(75) Inventor: James Christopher Milne, Issaquah, WA (US)

Correspondence Address: HONEYWELL/BLG;Patent Services, 101 Columbia Road, PO Box 2245, Morristown, NJ, 07962-2245, US

(73) Assignee: Honeywell International Inc., Morristown, NJ (US)

(21) Appl. No.: 12/354,621

(22) Filed: Jan. 15, 2009

(51) Int. Cl. C40B 50/08; C40B 60/14

(52) U.S. Cl. 506/27; 506/40

(57) ABSTRACT

Methods and apparatus for the fluid delivery and removal of micron scale structures that increase the efficiency of such fluid delivery and removal. An exemplary method for fluid delivery of a micron scale structure includes providing a silicon device that comprises a plurality of wells. Each of the wells includes a bottom wall, a side wall, a top opening and a plurality of protrusions that extend into the interior of the well. A plurality of micron scale structures are delivered into the wells using a fluid. The fluid is then removed from the wells, whereby spaces between the protrusions facilitate flow and removal of the fluid. The protrusions then retain the plurality of micron scale structures in the wells.

### BACKGROUND OF THE INVENTION

Fluid delivery and removal of micron scale structures is a commonly used technique which has many technical applications. For example, certain techniques for the analysis of biological molecules in a sample involve the fluid delivery of numerous micron scale beads or spheres having attached to their surfaces different chemical functional groups to a substrate having numerous discrete sites that can bind or hold the micron scale materials to form what is generally known as an array. Such fluid delivery is often inefficient since the fluid itself often removes a measurable portion of the micron scale structure from the discrete sites before they can be utilized for their intended use. Because of this, only a reduced portion of the micron scale beads or spheres are typically successfully bound or held in the discrete sites, which in turn results in many of the available discrete sites remaining unoccupied.

### SUMMARY OF THE INVENTION

Methods and apparatus for the fluid delivery and removal of micron scale structures that increase the efficiency of such fluid delivery and removal are disclosed.

In one embodiment, the present invention contemplates a method for fluid delivery of micron scale structures comprising providing a silicon or silicon dioxide device that comprises a plurality of wells, wherein each of the wells includes a bottom wall, a side wall, a top opening, and a plurality of protrusions that extend into the interior of the well, delivering a plurality of micron scale structures into the wells using a fluid or a vaporous form thereof, removing the fluid or the vaporous form thereof from the wells, whereby spaces between the protrusions facilitate flow and removal of the fluid or the vaporous form thereof, and allowing the wells with protrusions to retain the plurality of micron scale structures within the wells.

In another embodiment, the present invention contemplates an apparatus that increases the efficiency of fluid delivery of a micron scale structure that includes a silicon or silicon dioxide device that includes a plurality of wells, wherein each of the wells includes a bottom wall, a side wall, a top opening and a plurality of protrusions that extend into the interior of the well. The apparatus achieves this increased efficiency via the protrusions which facilitate flow and removal of the fluid (or its vaporous form), and allowing the wells with protrusions to retain the plurality of micron scale structures within the wells.

In a further embodiment, the present invention contemplates a method for fluid removal of a micron scale structure comprising providing a silicon or silicon dioxide device that has been etched to produce the micron scale structure, wherein the micron scale structure includes a plurality of protrusions extending from the surface thereof, and removing the micron scale structure from the silicon or silicon dioxide device using a fluid, whereby spaces between the protrusions decrease the surface contact area between the micron scale structure and the silicon or silicon dioxide device and facilitate flow of the fluid and removal of the micron scale structure.

In an additional embodiment, the present invention contemplates an apparatus for fluid removal of a micron scale structure comprising a silicon or silicon dioxide device that has been etched to produce the micron scale structure, wherein the micron scale structure includes a plurality of protrusions extending from the surface thereof and whereby spaces between the protrusions decrease the surface contact area between the micron scale structure and the silicon or silicon dioxide device and facilitate flow of a fluid and removal of the micron scale structure using the fluid.

As will be appreciated from the present application, the methodology of the present invention is particularly useful for increasing the efficiency of the fluid delivery and fluid removal of micron scale features in numerous applications. Efficiency is defined as the ratio of the number of devices retained or removed as compared to the number incident.

### BRIEF DESCRIPTION OF THE DRAWINGS

Preferred and alternative embodiments of the present invention are described in detail below with reference to the following drawings. For purposes of describing embodiments of the present invention, “micron scale structures” refers to a material, device or structure having at least one dimension that ranges in size from about 0.1 micron to about 1000 microns.

FIG. 1 is a schematic, top view of an exemplary apparatus for fluid delivery of a micron scale structure, in accordance with an embodiment of the present invention;

FIG. 2 is a schematic, side, cross-sectional view of an exemplary apparatus for fluid delivery of a micron scale structure, in accordance with an embodiment of the present invention; and

FIG. 3 is a schematic, top view of an exemplary system for fluid removal of a micron scale structure, in accordance with an embodiment of the present invention.

### DETAILED DESCRIPTION OF THE PREFERRED EMBODIMENTS

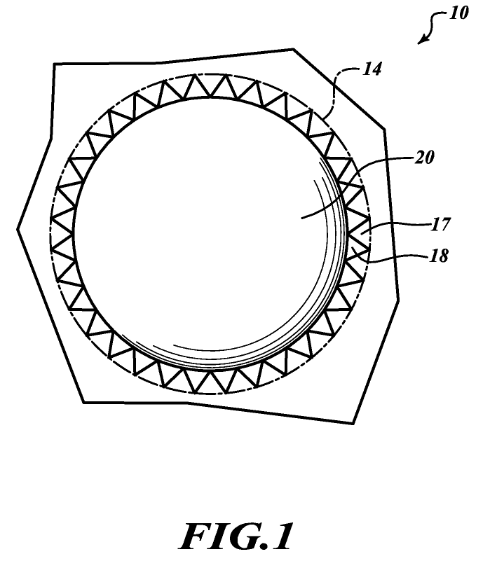

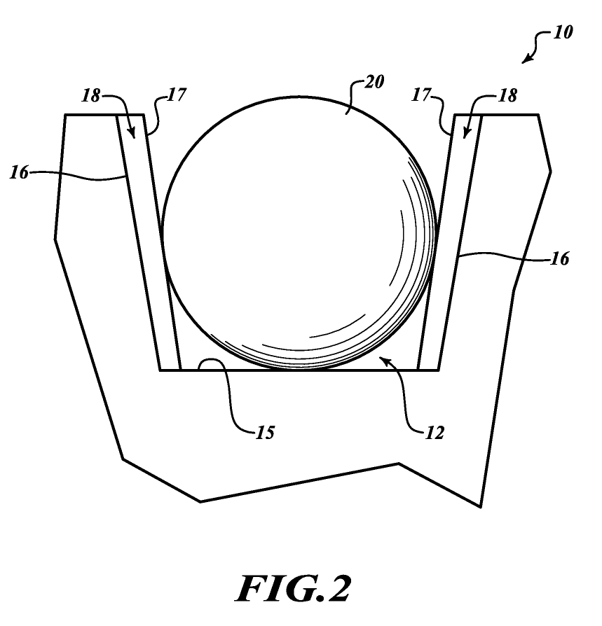

Referring now to FIG. 1, a schematic, top view of an exemplary apparatus 10 for fluid delivery of a micron scale structure 20, in accordance with an embodiment of the present invention, is shown. The apparatus 10 includes one or more discrete sites, which in the illustrated embodiment are one or more wells 12, that retain the micron scale structure 20 following fluid delivery. The wells 12 (FIG. 2) are defined by a wall 14 that includes a bottom wall 15 (FIG. 2), side walls 16 (FIG. 2) and protrusions 17 that extend around the radius of the side walls 16 into the interior of the well 12. Spaces 18 between the protrusions 17 facilitate fluid flow and removal of the fluid that is used to deliver the micron scale structure 20. The inner surfaces of at least a portion of the protrusions 17 come into contact with the micron scale structure 20 and retain it in the well 12 following fluid delivery of the micron scale structure 20.

Referring now to FIG. 2, a schematic, side view of an exemplary apparatus 10 for fluid delivery of a micron scale structure 20, in accordance with an embodiment of the present invention, is shown. As set forth above, the apparatus 10 includes the wells 12 defined by the wall 14 that includes the bottom wall 15, the side walls 16, the protrusions 17 and the spaces 18. In the illustrated embodiment, the opening at the top of the well 12 is larger than the bottom wall 15 of the well 12. This shape allows the micron scale structure 20 to enter the well 12. The protrusions 17 that extend from the sides walls 16 extend around the radius of the well 12 from the top opening of the well 12 to the bottom wall 15 of the well 12. As set forth above, the spaces 18 between the protrusions 17 facilitate fluid flow and removal of the fluid that is used to deliver the micron scale structure 20. More specifically, the fluid that is used to deliver the micron scale structure 20 can be removed from the well 12 through the spaces 18 and around the micron scale structure 20 so that the fluid itself does not wash the micron scale structure 20 from the well 12. Following fluid delivery of the micron scale structure 20 and removal of the fluid, the protrusions 17 act to retain the micron scale structure 20 in the well 12.

The present invention can be used for fluid delivery of micron scale structures in a wide variety of applications. In one embodiment involving fluid delivery, the micron scale structure is a plurality of micron scale beads or spheres having attached to their surfaces different chemical functional groups or molecules such as a deoxyribonucleic acid (DNA) probes for the analysis of analytes in a sample, and the apparatus for fluid delivery is a silicon device having numerous discrete sites that can bind or hold the micron scale structures to form what is generally known as an array. The array is used for the analysis of analytes, including for example nucleic acid molecules such as DNA molecules and ribonucleic acid (RNA) molecules, in a sample. In this embodiment, the discrete sites of the silicon device are typically micron scale holes having diameters of about 0.1 micron to about 1000 microns, with each silicon device containing about 100,000 to about one million such holes. The silicon device itself can have a multitude of sizes ranging from about 0.1 micron to about 1000 microns. The holes of the silicon device include protrusions which function as described above to facilitate fluid flow and therefore removal of the fluid that is used to deliver the micron scale beads or spheres and, following fluid delivery of the micron scale beads or spheres and removal of the fluid, to retain the micron scale beads or spheres in the holes. The micron scale beads or spheres in this embodiment have diameters of about 0.1 micron to about 1000 microns, with each silicon device incorporating from about 100,000 to about one million such micron scale beads or spheres. Suitable materials for fabrication of the micron scale beads include, for example, plastics, ceramics, glass, polymeric materials such as polystyrene and acrylic polymers and the like. The fluids used for delivery of the micron scale beads or spheres can include various components, including, for example, aqueous buffers, organic solvents, salts and other suitable components. The silicon devices used in this embodiment and having the protrusions as described above can be produced using various well-known techniques, for example, using photolithography masking techniques and subsequent plasma or wet chemical etching.

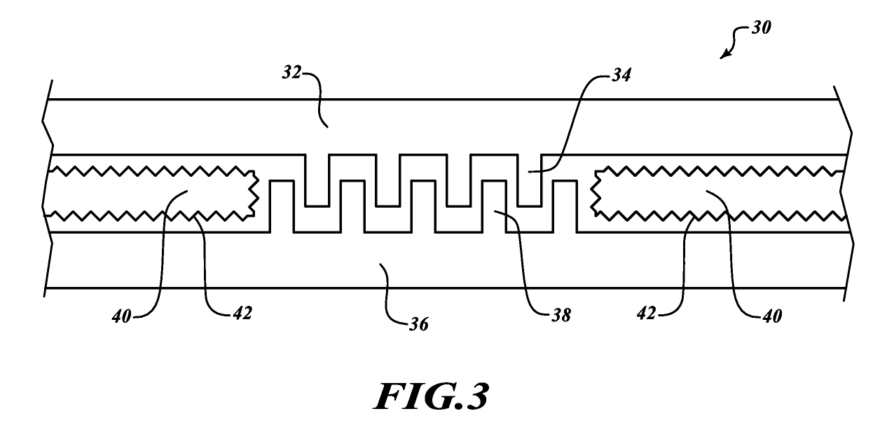

Referring now to FIG. 3, a schematic, top view of an exemplary system for fluid removal of a micron scale structure, in accordance with an embodiment of the present invention, is shown. The system involves a silicon or silicon dioxide device 30 which has been etched to include a top beam 32 having a plurality of tooth-like protrusions 34, a bottom beam 36 having a plurality of tooth-like protrusions 38 and blocks 40 that are positioned between the top beam 32 and the bottom beam 36. The blocks 40 serve to provide a uniform silicon etch, including a uniform size for the tooth-like protrusions 34 and 38 and uniform spacing between the top beam 32 and the bottom beam 36, and are removed following the etching process. The blocks 40, rather than having flat surfaces, have a plurality of protrusions 42 on their surfaces, thereby decreasing the area of contact of the blocks 40 with the top beam 32 and bottom beam 36. This in turn allows the blocks 40 to be more easily removed using a fluid removal procedure following the etching process. The silicon devices used in this embodiment and having the protrusions as described above can be produced using various well-known techniques, for example, using photolithography masking techniques and subsequent plasma or wet chemical etching. In an alternate embodiment, the protrusions 42 can placed on the top beam 32 and bottom beam 36 rather than the block 40.

The present invention can be used for fluid removal of micron scale structures in a wide variety of applications. In one embodiment of the fluid removal system set forth in FIG. 3, the silicon or silicon dioxide device 30 which has been etched to include the top beam 32 having the plurality of tooth-like protrusions 34 and the bottom beam 36 having a plurality of tooth-like protrusions 38 is a resonator of an accelerometer or gyroscope following fluid removal of the blocks 40. In this embodiment, the tooth-like protrusions 34 and 38 have heights of about 100 microns and widths of about 2 microns, with adjacent tooth-like projections 34 and 38 being separated by a distance of about 2 microns, and the blocks 40 have heights of about 100 microns and widths up to about ten thousand micron. Fluid removal of the blocks 40 in this embodiment is facilitated by megasonic or ultrasonic processing to vibrate the blocks 40 from their resting locations between the top beam 32 and the bottom beam 36.

While the preferred embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are: defined as follows:

1. A method for fluid delivery of a micron scale structure comprising:
providing a silicon device that comprises a plurality of wells, wherein each of the wells includes a bottom wall, a side wall, a top opening and a plurality of protrusions that extend into the interior of the well;
delivering a plurality of micron scale structures into the wells using a fluid;
removing the fluid from the wells, whereby spaces between the protrusions facilitate flow and removal of the fluid; and
allowing the protrusions to retain the plurality of micron scale structures in the wells.

2. The method of claim 1, wherein the protrusions extend around the radius of the wall from the top opening to the bottom wall of the well.

3. The method of claim 2, wherein each micron scale structure is a bead having attached to its surface a chemical functional group or molecule for the analysis of an analyte.

4. The method of claim 3, wherein the bead is a ceramic and the chemical functional group or molecule is a DNA probe.

5. The method of claim 4, wherein the bead has a diameter of about 0.1 micron to about 1000 microns

6. The method of claim 4, wherein the silicon device contains from about 100,000 to about one million wells and the wells have diameters of about 0.1 micron to about 1000 microns.

7. The method of claim 4, wherein the fluid used for delivery of the micron scale structure to the wells is an aqueous buffer solution.

8. An apparatus for fluid delivery of a micron scale structure comprising a silicon device that comprises a plurality of wells, wherein each of the wells includes a bottom wall, a side wall, a top opening and a plurality of protrusions that extend into the interior of the well.

9. The apparatus of claim 8, wherein the protrusions extend around the radius of the side wall from the top opening to the bottom wall of the well.

10. A method for fluid removal of a micron scale structure comprising:
providing a silicon device that has been etched to produce the micron scale structure, wherein the micron scale structure includes a plurality of protrusions extending from the surface thereof,
removing the micron scale structure from the silicon device using a fluid, whereby spaces between the protrusions decrease the surface contact area between the micron scale structure and the silicon device and facilitate flow of the fluid and removal of the micron scale structure.

11. The method of claim 10, wherein the silicon device has been etched to include a top beam having a plurality of protrusions, a bottom-beam having a plurality of protrusions and the micron scale structure is positioned between the top beam and the bottom beam.

12. The method of claim 11, wherein the protrusions of the top beam and the protrusions of the bottom beam have heights of about 100 microns and widths of about 2 microns and wherein adjacent protrusions on the top beam and bottom beam are separated by a distance of about 2 microns.

13. The method of claim 12, wherein the micron scale structure is a block having a height of about 100 microns and a width of about ten thousand microns.

14. The method of claim 13, wherein the fluid used for removal of the micron scale structure is an aqueous solution.

15. The method of claim 14, wherein removal of the micron scale structure is facilitated using megasonic or ultrasonic vibrations.

16. An apparatus for fluid removal of a micron scale structure comprising a silicon device that has been etched to produce the micron scale structure, wherein the micron scale structure includes a plurality of protrusions extending from the surface thereof and whereby spaces between the protrusions decrease the surface contact area between the micron scale structure and the silicon device and facilitate flow of a fluid and removal of the micron scale structure using the fluid.

17. The apparatus of claim 16, wherein the silicon device has been etched to include a top beam having a plurality of protrusions, a bottom-beam having a plurality of protrusions and the micron scale structure is positioned between the top beam and the bottom beam.

18. The apparatus of claim 17, wherein the protrusions of the top beam and the protrusions of the bottom beam have heights of about 100 microns and widths of about 2 microns and wherein adjacent protrusions on the top beam and bottom beam are separated by a distance of about 2 microns.

19. The apparatus of claim 18, wherein the micron scale structure is a block having a height of about 100 microns and a width of about ten thousand microns.
